(19) United States
(12) Patent Application Publication
(10) Pub. No.: US 2025/0383446 A1
(43) Pub. Date: Dec. 18, 2025

(54) COVERT SENSING AND COMMUNICATIONS USING QUANTUM ENTANGLEMENT-ASSISTED SPREAD SPECTRUM WAVEFORM CODING

(71) Applicant: Raytheon Company, Tewksbury, MA (US)

(72) Inventor: Mark J. Meisner, Tucson, AZ (US)

(21) Appl. No.: 18/646,135

(22) Filed: Apr. 25, 2024

Related U.S. Application Data
(60) Provisional application No. 63/462,684, filed on Apr. 28, 2023.

(51) Int. Cl. G01S 17/36; G01S 7/4911; G01S 7/4915

(52) U.S. Cl. CPC G01S 17/36; G01S 7/4911; G01S 7/4915

(57) ABSTRACT

A system for covert sensing and communications encodes a broadband light source using quantum entanglement-assisted waveform coding to spread a narrow-band signal over frequency. The light source generates broadband light and from that pairs of entangled photons that form a reference and a signal at different wavelengths. The signal is modulated and transmitted to illuminate a target. A phase conjugator mixes the reference with the broadband light to shift the reference to the same wavelength as the signal and performs a phase conjugation to output a phase conjugated reference as a local oscillator. An optical delay time delays the local oscillator to approximately match a time-of flight delay to the target and back. Light reflected from the target is combined with the local oscillator, detected using direct detection heterodyne, homodyne or quasi-homodyne techniques, demodulated and decoded to recover the narrow-band signal and estimate the phase of the reflected light relative to the transmitted light to provide fine range estimates for the target and a covert communications channel.

### CROSS-REFERENCE TO RELATED APPLICATIONS

This application claims benefit of priority under 35 U.S.C. 119(e) to U.S. Provisional Application No. 63/462,684 entitled “Systems and Methods for Covert Sensing and Communications” and filed on April 28, 2023, the entire contents of which are incorporated by reference.

### BACKGROUND

### Field

This disclosure relates to covert sensing and communication and more particularly to a system using quantum entanglement-assisted waveform coding.

### Description of the related art

In various commercial and military settings, it may be advantageous to measure the position of a target with high precision without alerting adversaries, e.g., commercial competitors or military adversaries, that the measurement is being performed. In related art sensors, methods for improving the covertness of a measurement may result in an unacceptable degradation of accuracy. It may also be advantageous to communicate with friendlies without alerting adversaries to the existence of the communication much less than content of the communication.

U.S. Patent No. 10,274,587 entitled “Covert Sensor” issued April 30, 2019 discloses a system for covert sensing. A broadband light source is split into two portions, a first portion of which illuminates a target, and a second portion of which is frequency shifted, e.g., by an acousto-optic frequency shifter. Light reflected from the target is combined with the frequency shifted light, detected using a heterodyne scheme, and demodulated with an in-phase and quadrature demodulator. The outputs of the demodulator are filtered and used to estimate the phase of the reflected light relative to the transmitted light to provide fine range estimates for the target.

### SUMMARY

The following is a summary that provides a basic understanding of some aspects of the disclosure. This summary is not intended to identify key or critical elements of the disclosure or to delineate the scope of the disclosure. Its sole purpose is to present some concepts of the disclosure in a simplified form as a prelude to the more detailed description and the defining claims that are presented later.

The present disclosure is directed toward a system for covert sensing and communications.

In an embodiment, a system for covert sensing and communications encodes a broadband light source using quantum entanglement-assisted waveform coding to spread a narrow-band signal over frequency. The light source generates broadband light and from that pairs of entangled photons that form a reference and a signal at different wavelengths. The signal is modulated and transmitted to illuminate a target. A phase conjugator mixes the reference with the broadband light to shift the reference to the same wavelength as the signal and performs a phase conjugation to output a phase conjugated reference as a local oscillator. An optical delay time delays the local oscillator to approximately match a time-of-flight delay to the target and back. Light returned from the target is combined with the local oscillator, detected using direct detection, heterodyne, homodyne or quasi-homodyne techniques, demodulated and decoded to recover the narrow-band signal and estimate the phase of the reflected light relative to the transmitted light to provide fine range estimates for the target.

In different embodiments, the broadband light source is configured to generate broadband light in one of the C, S or L bands having a bandwidth of at least 30 nm. The light source may, for example, be one of an amplified spontaneous emission (ASE) source, a light emitting diode (LED), a tunable narrowband laser and a laser with rotating ground glass to generate the broadband light and an optical amplifier to amplify the broadband light.

In an embodiment, the broadband light source includes a broadband source, fixed or tunable, an optical amplifier, an entanglement resource such as a non-linear crystal that generates pairs of entangled photons at different wavelengths from the broadband light to provide the signal and the reference, a wavelength separator to separate the signal and the reference, an arbitrary waveform generator and encoder to produce a sequence of encoded waveforms and a phase modulator configured to modulate the signal with the sequence of encoded waveforms.

In an embodiment, the waveform generator and encoder generate the coded waveforms for a signal using phase shift keying. The code length can be controlled to spread the narrow-band signal in frequency such that an amplitude is less than a detection threshold.

In an embodiment, the control circuit performs a time-correlation on the transmitted and received coded waveforms to estimate a time-of-flight and refine the delay. The code length may be longer than the time-of-flight.

In an embodiment, the cover sensor further includes a spontaneous emission noise source configured to add noise to the modulated signal. Suitably, an average power of the additional noise is less than an average power of the modulated signal and an average power of the composite coded waveform and additional noise is less than an average power of thermal background noise between the transmit and receive apertures.

In an embodiment, the series of coded waveforms are used to encode messages to form a covert communications channel.

These and other features and advantages of the disclosure will be apparent to those skilled in the art from the following detailed description of preferred embodiments, taken together with the accompanying drawings, in which:

### BRIEF DESCRIPTION OF THE DRAWINGS

Features, aspects, and embodiments are described in conjunction with the attached drawings, in which:

FIG. 1 is a block diagram of a covert sensor and covert communications system according to an embodiment of the present disclosure;

FIG. 2A is a block diagram of an embodiment of the light source to include classical waveform coding in noise;

FIG. 2B is a block diagram of an embodiment of the delay including frequency shift for heterodyne demodulation schemes;

FIG. 3 is a block diagram of an embodiment of the optical detector and control circuit configured for heterodyne, homodyne or quasi-homodyne detection;

FIGS. 4A-4B are diagrams illustrating embodiments of the application of classical waveform coding and spread spectrum techniques to improve covertness;

FIG. 5 is a diagram illustrating the addition of noise to the coded waveform to hide the waveform in the thermal background noise;

FIG. 6 is a flow diagram for using a time-correlation of the transmitted and received codeword packet to refine the delay and improve sensor performance; and

FIGS. 7A-7G are illustrations of the light at different positions in the block diagram in FIG. 1.

### DETAILED DESCRIPTION

The detailed description set forth below in connection with the appended drawings is intended as a description of exemplary embodiments of a covert sensor or communications provided in accordance with the present disclosure and is not intended to represent the only forms in which the present disclosure may be constructed or utilized. The description sets forth the features of the present disclosure in connection with the illustrated embodiments. It is to be understood, however, that the same or equivalent functions and structures may be accomplished by different embodiments that are also intended to be encompassed within the spirit and scope of the disclosure. As denoted elsewhere herein, like element numbers are intended to indicate like elements or features.

In a system for covert sensing and communications a broadband light source is encoded using quantum waveform coding to spread a narrow-band signal over a relatively larger band of frequencies. A light source generates broadband light and from that pairs of entangled photons that form a reference and a signal at different wavelengths. The signal is modulated using coded waveforms, suitably hidden in additional noise and then transmitted to illuminate a target. The broadband light is mixed with the reference to shift the reference to the same wavelength as the signal and then phase-conjugated to form a phase conjugated reference provided as a local oscillator. An optical delay time delays the local oscillator to approximately match a round-trip delay to the target, Light reflected from the target is combined with the local oscillator, detected using direct detection, heterodyne, homodyne or quasi-homodyne techniques, demodulated and decoded to recover the narrow-band signal and estimate the phase of the reflected light relative to the transmitted light to provide fine range estimates for the target. Waveform coding allows for time-correlation of the transmitted and received coded waveforms to provide improved resolution for adjusting the delay of the local oscillator to improve the detection schemes. The waveform coding also provides a covert communications channel.

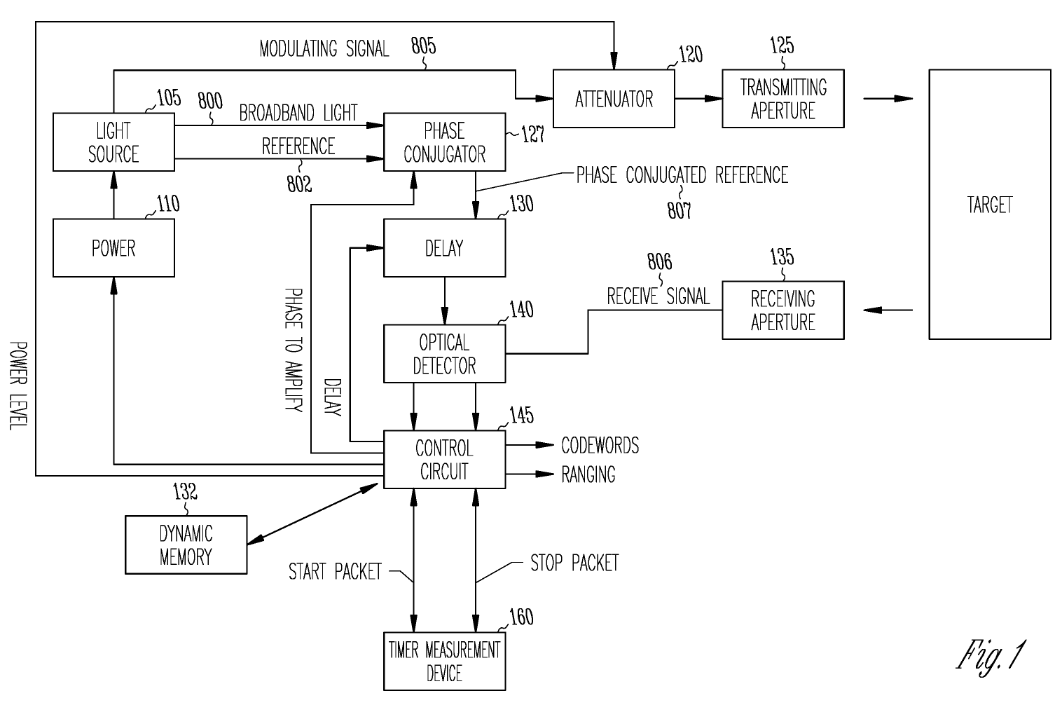

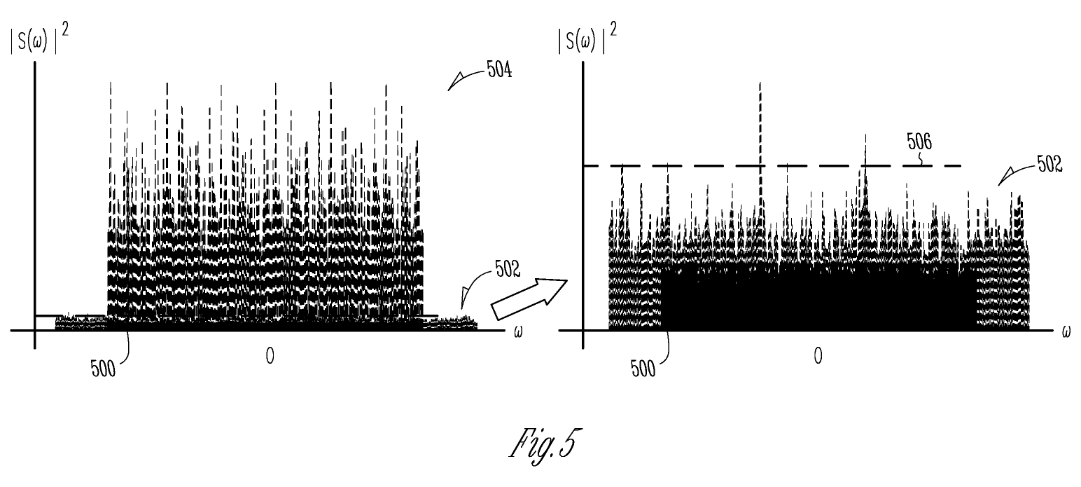

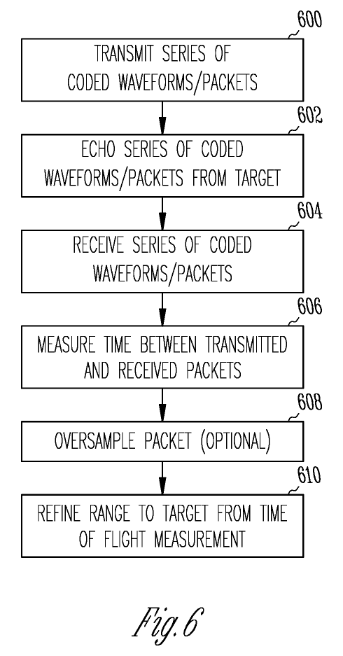

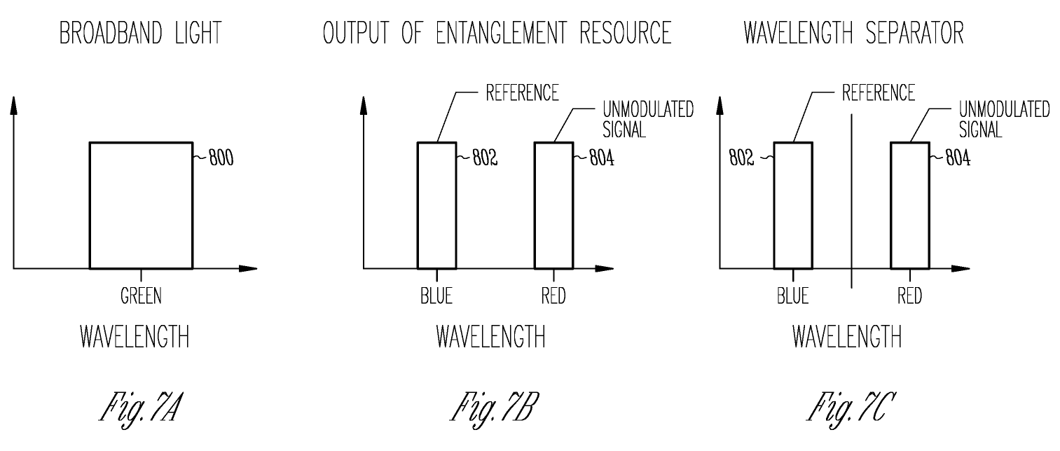

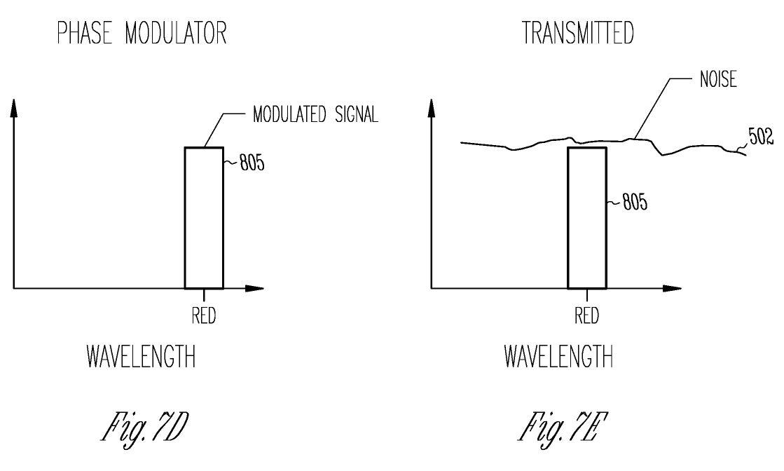

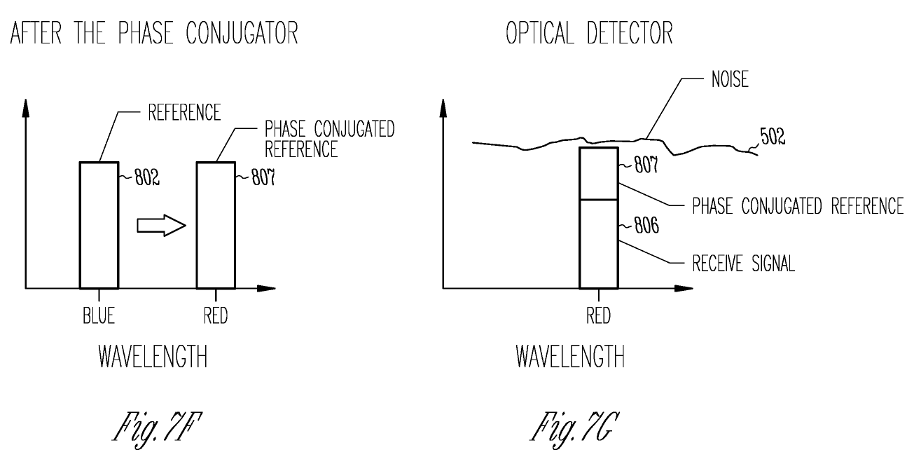

Referring to FIGS. 1 and 7A-7G, in some embodiments, a covert sensor includes a broadband thermal light source 105 powered by a power supply 110. Light source 105 provides broadband light 800, a reference 802 and a modulated signal 805. The reference 802 and an unmodulated signal 804 are generated from pairs of entangled photons derived from broadband light 800. The unmodulated signal (e.g. a narrow-band signal such as a single pulse) is modulated by a sequence of coded waveforms/codewords (e.g. a length N code) to spread the signal over a broader spectrum. Modulated signal 805 is fed to an attenuator 120 that feeds a transmitting aperture 125. A phase conjugator 127 mixes the reference 802 with the broadband light 800 to shift the reference to the same wavelength as the modulated signal 805 and performs a phase conjugation to output a phase conjugated reference 807 as a local oscillator. An optical delay 130, preferably adjustable time delays the local oscillator to approximately match a round-trip delay to the target. Light reflected from a target is received by a receiving aperture 135 as receive signal 806, and fed to a first input of an optical detector 140 (e.g., direct detection, heterodyne, homodyne or quasi-homodyne), a second input of which is fed by an output of the optical delay 130. The optical detector 140 has two electrical outputs each of which feeds a signal to a control circuit 145, which is connected to a dynamic memory 132 configured to store the transmitted coded waveforms (codewords). The control circuit 145 produces fine range estimates for the target, controls the power supply 110 and the attenuator 120, and provides a delay control signal, based on a time-correlation of the transmitted and received codewords, and local oscillator signal to the optical delay and optional frequency shifter 130. The control circuit 145 feeds control and waveform signals to the arbitrary waveform generator and encoder 225. The control circuit 145 generates refined range estimates to the target and provides a covert communications channel if desired.

Phase conjugator 127 may include a non-linear phase conjugator (NLPC). The NLPC also includes a phase sensitive amplifier. Control circuit 145 provides phase information to the NLPC to amplifier the phase conjugated reference 807. Reference Phase-conjugation by optical parametric amplification allows for beneficial features for optical communications—such as, a wideband, high gain, and fast transient response. During the phase sensitive amplification process, the optical reference is explicitly phase-conjugated. The phase conjugate of an optical signal is a light beam which has its phase complex conjugated with respect to the original signal beam. In more detail, optical phase conjugation (OPC) is defined as the relationship between two coherent optical beams propagating in opposite directions with reversed wave front and identical transverse amplitude distributions. This allows for various beneficial optical signal processes—for example, fiber-nonlinearity mitigation, wavelength conversion, and phase sensitive amplification, and optical parametric and phase-conjugated detection and correlation can be performed. Furthermore, various non-linear optical parametric amplification material system—for example, Periodically-poled Lithium Niobate (LiNbO3, PPLN)—waveguides permit beneficial wideband and high-gain amplification possible.

In operation, the broadband thermal light source 105 provides light both to illuminate the target (through the attenuator 120, and the transmitting aperture 125), and to provide the local oscillator (through the phase conjugator 127 and the optical delay and (optional) frequency shifter 130) to the optical detector 140. In the optical detector 140, the reflected light received from the target (via the receiving aperture 135), is, as described in further detail below, in a heterodyne scheme mixed down to an intermediate frequency electrical signal, with the intermediate frequency being determined by the magnitude of a frequency shift applied by the optical delay and frequency shifter 130. For the homodyne scheme, the intermediate frequency signal is mixed down to baseband. For the various coherent detection schemes, the formed in-phase signal and a quadrature phase signal are fed to the control circuit 145. In a homodyne or quasi-homodyne scheme, the reflected light is mixed with the local oscillator at the same frequency as the signal. Homodyne or quasi-homodyne schemes require accurate delay, which can be provided by correlation of the transmitted and received codewords, but provides improved sensitivity and signal-to-noise ratio (SNR).

The transmitted and returned signal can be used to determine the distance to target by the determination of the time-of-flight from the transmitter to the target and back to the receiver aperture. Distance is determined by multiplying the velocity of light by the time light takes to travel the distance; in this case, the measured time is representative of traveling twice the distance and must, therefore, be reduced by half to give the actual range to the target. Typically for covert low transmit power conditions, the received returned signal is very weak which can cause reception ambiguities. The use of a series of unique and well-defined pulses (codeword packets) can dramatically reduce receive ambiguities by oversampling and matching the returned signal and correlating with the transited signal.

In order to maximize the improvement in bit error rate it is important to delay the reference so that the photons in an entangled pair are matched. The time-delay should be “close” e.g., within a meter or so but does not require onerous alignment. This is a result because the transmitted signal and received signal are correlated in time (approximate optical path lengths) and digitally using codeword matching.

In an embodiment of the entanglement resource the entangled twin photon (signal and reference) beams are generated by using spontaneous parametric down-conversion (SPDC). The signal beam interrogates a region of space that is suspected of containing one or more targets. Typically, the interrogated environment (e.g., the atmosphere) is lossy and noisy which might result in entanglement breaking of signal and reference photon-pairs.

In some embodiments, the SPDC device also includes a nonlinear crystal which is used to perform spontaneous parametric down-conversion. The nonlinear crystal may be constructed from any suit able material; for example, lithium niobate, lithium tantalate, potassium niobate, potassium titanyl phosphate, potassium dihydrogen phosphate, potassium dideuterium phosphate, lithium triborate, cesium lithium borate, cesium borate, yttrium calcium oxyborate, strontium beryllium borate, zinc germanium diphosphide, silver gallium sulfide, silver gallium selenide, cadmium selenide, silicon dioxide, gallium arsenide, or any combination thereof.

The receiver performs a joint measurement on the returned signal light and the reference beam that is retained in the transmitter. An optimal quantum receiver will achieve at least a 4, or higher, decibel gain in the error-probability exponent relative to that achieved with a single coherent-state (classical) laser transmitter and the optimum receiver. In some embodiments, the quantum receiver might be composed of a low-gain optical parametric amplifier (OPA) and ideal photon counting detector, or a phase conjugation receiver/ mixer followed by balanced dual detectors. Both receiver approaches endeavor to detect the remnant phase-sensitive cross correlation between the signal-return and reference mode pairs when the target is present. The quantum entanglement-aided optical sensor for target detection, substantially outperforms the coherent classical sensors in the low-brightness, high-loss, and high-noise operating regimes.

In some embodiments, the signal and reference beams are composed of optical wavefronts that contain information. When passing through various medium, the optical wavefronts become distorted and scattered which degrades the signal and reference beam information quality. Optical phase conjugation (OPC) is a nonlinear technique used for counteracting wavefront distortions and scattering losses. For example, optical phase conjugation is used to compensate for various propagation-path distortions, including atmospheric turbulence, aberrations in laser gain media and optical components, beam wander, and modal dispersion in guided-wave structures.

In some embodiments, the non-linear phase conjugator (NLPC) provides higher detection sensitivities for sensors that the signal beams are subjected to practical and undesirable medium (e.g., atmospheric) effects, such as off-axis scattering and random scatter motion. The first issue pertains to the reduction of off-axis scattering experienced by a probe beam of light that propagates from a remote sensor to an interrogator over the path; the second issue involves the sensing and quantification of any global motion of the scattering sites in the presence of background, random motion. Using nonlinear optical phase conjugation techniques, a wavefront-reversed replica of an incident probe beam can be realized that reduces off-axis scattering on its return transit through a medium and, at the same time, senses the presence of global phase shifts due to a net motion of an otherwise randomly moving ensemble of scatterers. Furthermore, optical phase conjugation still reduces the effects of scattering losses in remote sensing and two-way communications, especially if not all the scattered light is collected by the receiving aperture or if the scattered light is not processed by the conjugator.

As shown in FIG. 6, time measurement device 160 generates and receives start and stop packet commands with control circuit 145. The covert sensor transmits a series of unique codeword packets/pulses via the transmitting aperture (step 600). The target echoes a series of unique codeword packets/pulses (step 602), which are received by the receiving aperture (step 604). Control circuit 145 measures/samples the time between the transmitted and received codeword packets (step 606). This can be done by measuring each codeword packet (“undersampling”) or by measuring each unique pulse in each codeword packet (“oversampling”) (step 608). The concatenation of the measurements in oversampling provides more accurate time measurements. Control circuit 145 refines the range to target, hence the delay provided to delay 130 from the time-of-flight measurements (step 610).

Furthermore, if the length of the codeword packet is longer than the round-trip time than the covert sensor will start to receive initial pulses of the packet before the later pulses of the packets are transmitted. For example, packet length may be on the order of 1 ms, and the round-trip time < 1 ms.

As discussed in further detail below, a change in the position of the target (e.g., in the range to the target) changes the round-trip delay experienced by light reflected from the target, and it therefore also changes the in-phase signal and a quadrature phase signal that are fed, by the optical detector 140, to the control circuit 145. The phase of the signal reflected from the target, relative to the phase of the local oscillator (optical signal), is estimated, from the in-phase signal and the quadrature phase signal, as discussed in further detail below, by the control circuit 145. The control circuit 145 may therefore also generate, from the phase estimate, (i) an estimate of the phase of the light received by the receiving aperture relative to the phase of light radiated by the transmitting aperture (because delays internal to the sensor may be known), and, (ii) from this relative phase, a fine range (e.g., measured as a fraction of the wavelength of the light) of the target. The light source may be sufficiently broadband that the number of photons emitted, per mode, per unit time, is small; this low photon flux rate may be a significant obstacle to detection of the transmitted beam. Indeed, it may be shown that the probability of detection may be made arbitrarily small by suitable selection of the parameters of operation (including the bandwidth of the light source, and the amount of power transmitted). The covertness is further aided by the use of classical waveform coding, which both encodes/encrypts any signal and spreads the energy of the signal across the broadband frequency. The covertness is even further aided by intentionally adding noise to the coded waveform at a level that hides the coded waveform in the thermal background noise. The use of coded waveforms also provides a covert communications channel if one is desired.

The output of the broadband thermal light source may be a beam propagating in free space or it may be light guided in a fiber. Similarly, optical signals at any of the inputs and outputs of the elements of FIG. 1 may be beams propagating in free space or light guided in respective fibers, except that each of the signal at the output of the transmitting aperture 125 and the signal at the input of the receiving aperture 135 consists of (optical) electromagnetic waves, propagating in free space. Each of the transmitting aperture 125 and the receiving aperture 135 may be a telescope.

In some embodiments the transmitting aperture 125 and the receiving aperture 135 are shared, i.e., they are a single optical device (e.g., a single telescope) with a suitable optical arrangement to separate outgoing and incoming light. The attenuator 120 may be an electronically controlled attenuator, controlled by a (digital or analog) control signal from the control circuit 145. The attenuator 120 may control the amount of power transmitted through the transmitting aperture 125 (e.g., reducing the transmitted power to a level providing acceptable covertness).

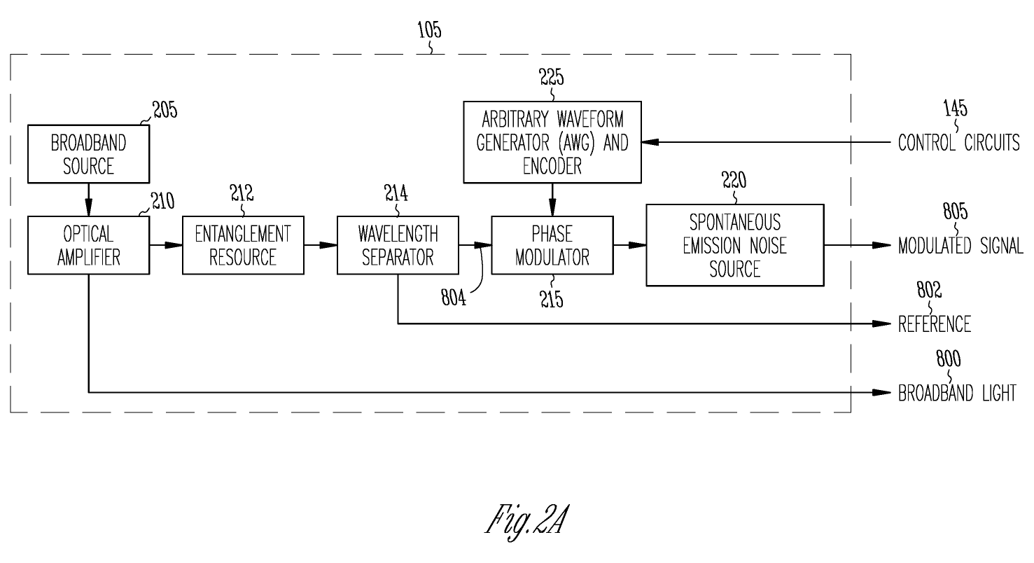

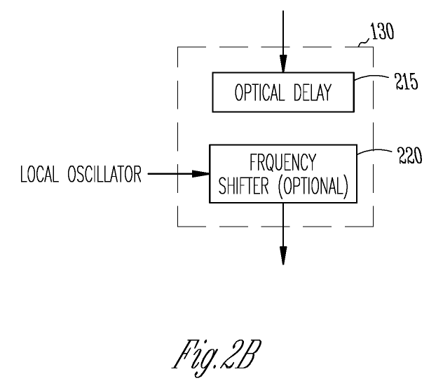

Referring to FIG. 2A, the broadband thermal light source 105 may include a broadband light source 205, an optical amplifier 210, quantum entanglement resource 212, wavelength separator 214, an arbitrary waveform generator (AWG) and encoder 225, a phase modulator 215 and a spontaneous emission noise source 220. Broadband light source 205 may, for example, include a C-Band amplified spontaneous emission (ASE) source with an optical wavelength range of about 1530 nm to about 1565 nm, an S-Band source (about 1460 nm to about 1530 nm) or an L-Band source (about 1565 nm to about 1625 nm). The broadband light source 205 may alternately include a broadband light emitting diode (LED), a tunable laser source or a broadband laser with rotating ground glass. Optical amplifier 210 may include an erbium doped fiber amplifier (EDFA). The output of the EDFA may be relatively broadband, having a (3 dB) bandwidth of about 1 THz, or 2 THz, or more. The relatively large bandwidth of the light may improve the covertness of the sensor, as mentioned above.

Quantum entanglement resource 212 such as a non-linear crystal (e.g., a periodically polled lithium niobate crystal) generates pairs of entangled photons at different wavelengths from each other and the light source. One of the wavelengths is reference 802 and the other wavelength is the unmodulated signal 804. An entangled pair includes a photon in the reference 802 and a photon in the unmodulated signal 804.

Wavelength separator 214 separates the unmodulated signal 804 from the reference 802.

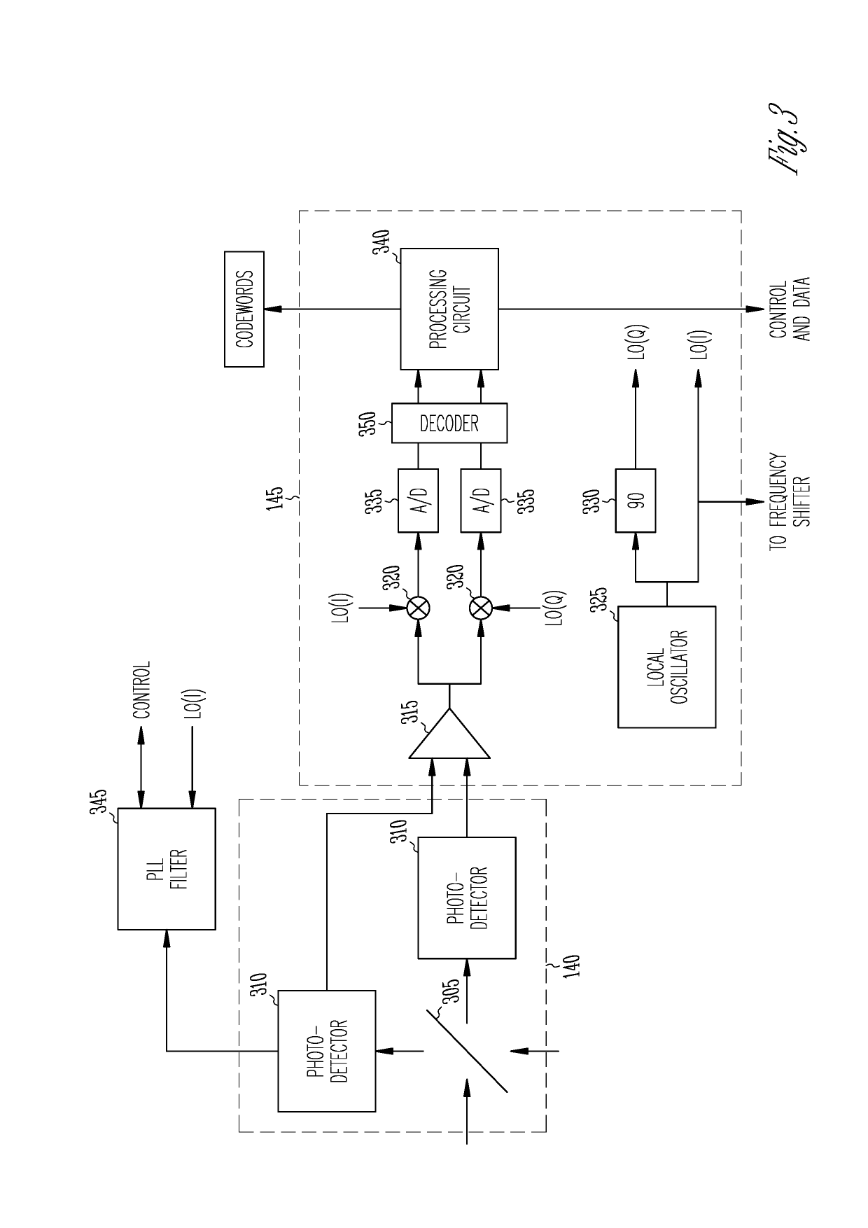

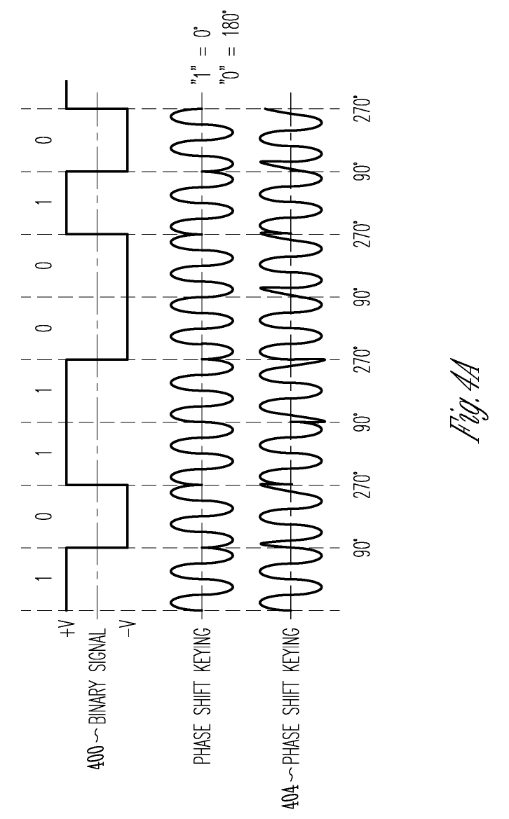

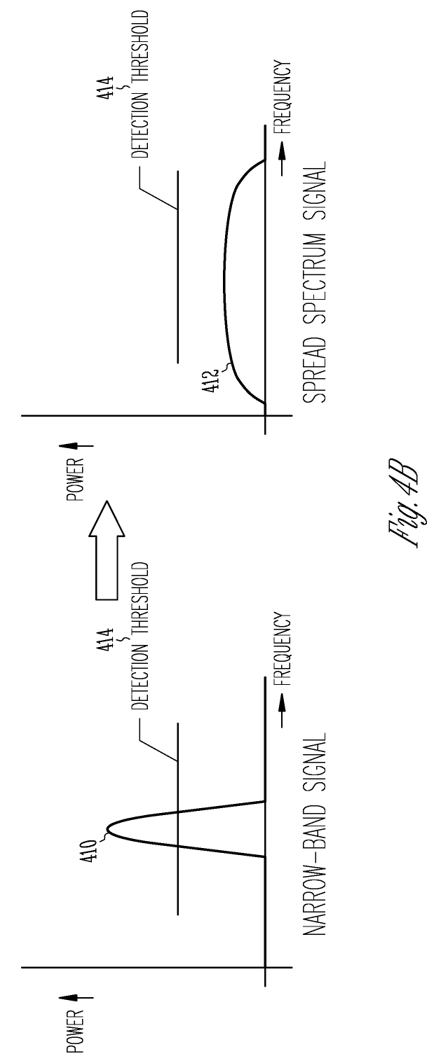

The AWG and encoder 225 may apply coded waveforms such as low-density parity check (LDPC)-coded binary phase shift keying (BPSK) modulation 402 to a binary signal 400 as shown in FIG. 4A and various other modulation schemes based on codewords provided by control circuit 145. The coded waveforms generated from the arbitrary waveform generator 225 may allow the phase modulator 215 to modulate the broadband light; the modulated broadband light may improve the covert of the sensor; the modulated broadband light may improve the sensing accuracy of the sensor. As shown in FIG. 4B, a narrow-band signal 410 (e.g., a single pulse of binary signal 400) is broadened into a length N (e.g. 256 bit) codeword into a spread spectrum signal 412 that lies below the detection threshold 414 of an adversary.

Spontaneous emission noise source 220 may also be an EDFA. The output of spontaneous emission noise source 220 may add noise power (e.g., due to the spontaneous emission in the erbium doped fiber amplifier) to improve the covertness of the modulated signal 805. The level of added noise power should be sufficient to hide the modulated broadband light in the thermal background noise without being detectable. More specifically, the average power of the additional noise 500 should be less than an average power 506 of modulated broadband light 502. Furthermore, an average power of the coded waveform and the additional noise should be less than an average power of thermal background noise 504 between the transmit and receive apertures. S(w) is the composite signal as a function of frequency where 0 is a relative central frequency.

In other embodiments a different broadband thermal light source with suitable characteristics (e.g., adequate bandwidth) may be used. For example, the broadband thermal light source may include a semiconductor laser generating light at about 1550 nm or at about 1590 nm, a thulium doped fiber amplifier (with gain in the S-band (1450-1490 nm)), a praseodymium doped amplifier (with gain in the 1300 nm region) or an ytterbium doped fiber amplifier (with gain at wavelengths near 1 micrometer). In such a system, a laser producing light in the wavelength range within which the amplifier has gain may supply light to the input of the amplifier (e.g., an ytterbium doped fiber laser may be used with an ytterbium doped fiber amplifier). Apart from their broad gain bandwidth, ytterbium doped fiber amplifiers may offer high output power and a much better power conversion efficiency than EDFAs.

In an embodiment such as illustrated in FIGS. 7A-7G, the light source may be viewed as generating light at particular “colors”. For example, light source 205 might generate light at 1529.75 nm (“green”) with a bandwidth of at least 50 nm. Acting on the green light, the entanglement resource may generate the reference at 1510 nm (“blue”) and the signal at 1550 nm (“red”). The reference and signal may have bandwidths of at least 20 nm.

Covert sensing and communications use broad bandwidth illumination. A scheme for covert active sensing and communications using broad bandwidth illumination source and balanced homodyne or heterodyne detection. Wherein for sensing and communications the transmitted signal and received phase information is kept undetectable to a quantum-equipped passive adversary, by hiding the signal and return photons under the thermal-environmental noise floor. There are several options for appliable broad bandwidth sources; for example, a C-Band amplified spontaneous emission (ASE) source, with an optical wavelength range of about 1530 nm to about 1565 nm; other common optical bands are also possible, such as S-Band (about 1460 nm to about 1530 nm) and L-Band (about 1565 nm to about 1625 nm). The quantum states of each mode of the ASE source are thermal (mixed) and have thousands of times higher optical bandwidth in comparison to a pure coherent state of a laser mode. The extremely large optical bandwidth results in achieving a substantially superior performance compared to a narrowband laser source by allowing the transmitted light to be spread over many more orthogonal temporal modes within a given integration time.

High sensitivity detection and good anti-interference performance are important for sensing and communications. The time-length adjusted balanced detection can function as an extremely selective filter for the returned signal, so as, to enhance the anti-interference performance and improve the sensitivity. Several balanced detection schemes are supported, heterodyne and homodyne, quasi-homodyne detection. For example, heterodyne detection usually exploits frequency shifting to generate the frequency difference between the returned signal and the local laser. The frequency difference is generally about 80 MHz to 150 MHz for example, which is usually much larger than the bandwidth of transmitted source pulse, with duration times generally about 100 ns to 300 ns for example. (The optical bandwidth of a pulse cannot be narrower than the reciprocal of the pulse width.) Broadband detection is required to receive the high frequency beating signal, which limits the transimpedance gain in the detector and causes larger thermal noise. For lower thermal and current noise and improved signal-to-noise ratio (SNR) and sensitivity, quasi-homodyne and homodyne detection schemes are possible. Thus, the returned signal is recovered in base band directly by phase-locking. Which allows for much smaller detection bandwidth, which is closer to the bandwidth of the source pulses, so as, to effectively reduces thermal noise and currents.

To increase the security of the covert sensing and communications channel, the secure signal has a frequency spectrum profile very similar to the propagation links and channels. For example, a broadband source, such as amplified spontaneous emission (ASE) light, is a natural optical carrier to hide a message in existing networks and environments. ASE photons have random distributions of wavelength, phase, and polarization. The secure signal is initially encoded, and time spread, by an encoder, and consequently becomes noise-like with low power density. The encoded signal is also modified by the addition of noise from a spontaneous emission amplifier. The signal and return signal steganographic channels will be shaped (e.g., masked composite) optical signals composed of environmental noise, added spontaneous emission amplifier noise, and cryptographically modulated broadband light.

The signal and returned signal are also steganographic covert through signal message modulation. Thus, information is hidden by embedding messages within other messages and the environment in such a way that no one apart from the intended recipient knows of the existence of the message. The covert channel is optically encoded and temporally spread, with an average power below the noise floor in the environment, making it hidden from adversarial direct detection (e.g., eavesdropper) thus allowing for cryptographic and steganographic security capabilities.

Cryptographic codewords (packets) are allow for additional signaling and communications security. Transmit data maybe in fixed-length packets, and the packet may consist of several codewords. For sensing a signaling channel is developed between the transmitter and target and back to the receiver; and for communications a protected communication link established between the sender and receiver. The cryptographic modules encoded and decoded codewords. The secure channel allows secure communication and verification messages, keys, authentication data, and other sensitive data.

The signal and return packet maybe be effectivity long in time and equivalently distance. Portions and the packet and codewords may be used as a signal and return pulse correlation selective filter. The signal and returned optical signal may be received and corelated to transmission times, which allows for effectively digital adjustments in the delay line for the balanced (homodyne, quasi-homodyne, or heterodyne) detection process. For illustration, various modulated thermal source-based signaling is used for sensing and communications. For illustration, phase shift keying (PSK) is a modulation process which conveys data by changing (modulating) the phase of a constant frequency carrier wave(s). The modulation can be accomplished by varying the sine and cosine inputs at specific times.

Referring to FIG. 2B, in some embodiments the optical delay 130 includes an optical delay 215 and a frequency shifter 220 (optional). The optical delay 215 may be adjustable in increments comparable to the coherence time of the light source 105, e.g., in increments of about 0.5 picoseconds if the light source 105 has a bandwidth of about 2 THz. In FIG. 2B the frequency shifter 220 is illustrated as following the optical delay 215; in other embodiments the frequency shifter 220 may instead precede the optical delay 215. Frequency shifter 220 is not required for homodyne or quasi-homodyne detection schemes.

The optical delay may include a cascade of switched banks of fixed optical delays e.g., spools of optical fiber of different lengths. For example, to construct an adjustable optical delay with a range of 10 m, and an increment of 1 cm, a cascade of ten stages of switched banks of delays (each bank including two different delays) may be used.

In one such embodiment, a first stage is controllable to select between two fibers differing in length by 10 m (e.g., one fiber having a length of 1 m and another having a length of 11 m), a second stage is controllable to select between two fibers differing in length by 5 m, a third stage is controllable to select between two fibers differing in length by 2.5 m, and so on, with each stage providing a capability to switch between two lengths differing by an increment that is half that of the previous stage. In such a system the tenth stage may provide an increment of slightly less than 1 cm.

A fine delay adjustment may then be provided, for example, in free space, using a wedged optic on a motorized transverse translation stage, or, in fiber, using a temperature-controlled fiber, or the like. The frequency shifter 220 may be an acousto-optic frequency shifter, fed by a local oscillator signal that may be generated by a local oscillator 325 within the control circuit 145 (FIG. 3). The control circuit 145 may adjust the optical delay 215 so that the difference between (i) the total delay in the path from the light source 105 to the optical heterodyne block 140 through the combined optical delay and frequency shifter 130 and (ii) the total delay in the path from the light source 105 to the optical heterodyne block 140, through the path that includes reflection from the target, is less than or comparable to the coherence time of the light source 105. A separate coarse sensor (e.g., a Lidar or radar sensor, not shown) may be used to provide the coarse range to the target, from which the control circuit 145 may calculate the appropriate delay setting for the optical delay 215. In some embodiments the coarse sensor also uses the light source 105, e.g., using a portion of the light, diverted by an additional beam splitter. The optical delay may be further refined using the time-correlation of the transmit and receive codeword packets previously described.

FIG. 3 shows the optical detector 140 and the control circuit 145, in one embodiment. This embodiment can be used to support either heterodyne or homodyne detection depending on its exact configuration. The optical detector 140 has two optical inputs, as mentioned above. Light from the two inputs interferes at a beam combiner 305 (e.g., an optical free space (partially reflective) beam splitter, or a fiber splitter) and light from the two outputs of the beam combiner 305 is detected by two respective photodetectors 310. The outputs of the photodetectors feed (directly, or indirectly, e.g., through respective transimpedance amplifiers that may be integrated into the photodetectors 310) a differential amplifier 315, which feeds two mixers 320, the local oscillator inputs of the two mixers being connected, respectively, to the in-phase and quadrature outputs of a circuit including a local oscillator 325 and a 90-degree phase shifter 330. The local oscillator 325 may produce a signal with a frequency (the intermediate frequency of the receiver) that is less than about 10 or 20 percent of the bandwidth of the light source 105, e.g., a signal at about 200 GHz or less. In some embodiments, a significantly lower frequency, e.g., 100 MHz, is used as the intermediate frequency, to simplify the construction of the optical heterodyne block 140 and the control circuit 145.

Each of the photodetectors 310 may be constructed to have acceptable sensitivity at the intermediate frequency, e.g., as a result of having a bandwidth greater than the intermediate frequency, or as a result of being part of a resonant circuit having a resonant frequency near the intermediate frequency (e.g., as a result of being part of a circuit including an inductor connected as a shunt across a photodiode of the photodetector, the inductor and the capacitance of the photodiode forming a resonant LC circuit). The intermediate frequency (IF) ports of the two mixers 320 (which carry the baseband signal, as a result of mixing the intermediate frequency signal from the photodetectors down to baseband) are connected to the respective analog inputs of two analog to digital converters 335, the outputs of which are connected to a decoder 350, which decodes the codewords into the narrow-band signal and provides the narrow-band signal (e.g., the pulse) to processing circuit 340, suitably to an electronic, optical or quantum processor. The sampling rate of the analog to digital converters 335 may be at least equal to twice the bandwidth of the analog circuitry feeding their inputs (e.g., the bandwidth of the photodetectors 310, or the bandwidth of each of two anti-aliasing filters (not shown) connected in cascade with the respective inputs of the analog to digital converters 335).

For homodyne detection, a Phase Locked Loop (PLL) Filter 345 has inputs connected to receive LO(I) from the local oscillator, an input from photodetector 310 and a phase form control circuit 145 and generates a control output that is provided to processing circuit 340. Optical phase locking is normally included for homodyne and quasi-homodyne detection, to achieve phase synchronization between reference source pulses and local laser. Dynamical phase-compensation is used to track the phase of the reference source pulses. By phase-locking of the reference pulses to local laser, the stability of the phase synchronization can be improved, so as, to improve the reliability of the system. The signal and return pulse synchronization (phase locking) is needed for homodyne, quasi-homodyne, and heterodyne detection. The phase locking allows for sensing and communications detection, which can be used in light detection and ranging (e.g., laser radar) and quantum key distribution systems, with significant detection sensitivity and anti-interference advantages.

In some embodiments, the sensor includes a photon counter. For example, the photon counter is a single-photon detector. Optionally, the single-photon detector is used for many detected modes. In some embodiments, the number of detected modes may be greater than 1,000,000. In a direct detection system, the information is coded into the intensity or amplitude of the light. The receiver will have a detector (e.g., a photodiode) which will convert the intensity of light into an electrical signal. The information is directly recovered from this electrical signal; an example of noncoherent detection is direct detection of on-off-keying (OOK); and to encode more than one bit per symbol multilevel amplitude-shift keying (ASK) or frequency-shift keying (FSK) can be used.

In some embodiments, differentially coherent phase detection may be exploited. In differentially coherent detection, a receiver computes decision variables based on a measurement of differential phase between the symbol of interest and one or more reference symbol. For example, in differential phase-shift keying (DPSK), the phase reference is provided by the previous symbol.

In other embodiments, a hybrid of noncoherent and differentially coherent detection approaches may be used. A hybrid of noncoherent and differentially coherent detection can be used to recover information from both amplitude and differential phase. For example, one such format is polarization shift keying (PolSK), which encodes information in the Stokes parameter.

In some embodiments, coherent detection approaches may be utilized. Where for coherent detection the receiver computes decision variables based on the recovery of the full electric field, which contains both amplitude and phase information. Coherent detection allows for flexibility in modulation formats, as information can be encoded in amplitude and phase; that is, in both in-phase (I) and quadrature (Q) components of a carrier. Coherent detection requires the receiver to determine the carrier phase; the received signal is demodulated by a local oscillator (LO) that serves as an absolute phase reference. Typically, carrier synchronization may be performed by a phase-locked loop (PLL) filter approach.

The term “processing circuit” is used herein to mean any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example, a processing circuit may include two processing circuits, an FPGA and a CPU, interconnected on a PCB.

In some embodiments, the processing circuit 340 receives a stream of in-phase samples and a stream of quadrature phase samples from the analog to digital converters 335, filters each stream, and periodically calculates an inverse tangent of the ratio of (i) the filtered quadrature phase samples to (ii) the filtered in-phase samples. The filtering may consist of forming a weighted sum of a plurality of consecutive samples, e.g., forming a running (boxcar) average of each stream, or applying another finite impulse response (FIR) filter (i.e., one with non-uniform coefficients) to each stream. In other embodiments, the filtering may consist of applying an infinite impulse response (IIR) filter to each stream.

In some embodiments, the processing circuit 340 receives may decode the phase modulated (e.g., coded waveforms such as low-density parity check (LDPC)-coded binary phase shift keying (BPSK) modulation and various other modulation schemes) and digitality converted in-phase and quadrature phase samples allow for covert communications with cooperative and collective targets.

In more detail, within the processing circuit, many target and codeword detection hypothesis decision rules are possible. For example, the hypothesis may consider the mean photon number per mode and the entanglement-assisted cross-correlation and/ or phase-sensitive cross-correlation between the return beam and the delayed reference beam signal.

In some embodiments, the average power of the secure signal is much lower than the amplifier noise, and consequently the secure signal is fully masked by the amplifier noise. At the receiving side balanced detectors (e.g., photoreceivers) are used for covert data recovery with a relevant decoder (through conjugate demodulation and de-shaping). The decoder is the similar as the encoder with the phase mask (phase modulation) replaced with a digital conjugate. By controlling the initial input power of the signal transmitted and the code length (which determines the amount of time spreading) a given BER (bit-error-rate) for a required level of performance can be achieved.

It will be understood that when an element or layer is referred to as being “connected to” another element, it may be directly connected to the other element, or one or more intervening elements may be present. In contrast, when an element or layer is referred to as being “directly connected to” another element, there are no intervening elements present.

Although limited embodiments of a covert sensor or communications have been specifically described and illustrated herein, many modifications and variations will be apparent to those skilled in the art. Accordingly, it is to be understood that a covert sensor employed according to principles of this disclosure may be embodied other than as specifically described herein. The disclosure is also defined in the following claims, and equivalents thereof.

I claim:

1. A covert sensor, comprising:
a light source configured to generate broadband light;
an entanglement resource that interacts with the broadband light to generate pairs of entangled photons to form a reference and a signal at different wavelengths;
a wavelength separator configured to separate the signal and the reference;
a waveform generator and encoder configured to generate a sequence of coded waveforms for a narrow-band signal;
a phase modulator configured to modulate the signal with the sequence of coded waveforms and output a modulated signal;
a transmitting aperture configured to receive the modulated signal and radiate the light in a free-space beam towards a target;
a receiving aperture configured to receive light including coded waveforms from the target;
a phase conjugator configured to mix the reference with the broadband light to shift the reference to the same wavelength as the signal and to perform a phase conjugation to output a phase conjugated reference as a local oscillator;
an optical delay configured to time delay the local oscillator to approximately match a time-of-flight delay to the target and back;
an optical detector configured to mix the received light with the time-delayed local oscillator signal to form one or more signals; and
a control circuit configured to process the one or more signals to estimate a phase of the light received by the receiving aperture relative to a phase of light radiated by the transmitting aperture to estimate a range to the target.

2. The covert sensor of claim 1, wherein the light source is configured to generate broadband light in one of the C, S or L bands having a bandwidth of at least 30 nm, wherein the light source comprises one of an amplified spontaneous emission (ASE) source, a light emitting diode (LED), a tunable laser and a laser with rotating ground glass to generate the broadband light and an optical amplifier to amplify the broadband light.

3. The covert sensor of claim 1, wherein the waveform generator and encoder generate the coded waveforms for a signal using phase shift keying.

4. The covert sensor of claim 3, wherein the waveform generator and encoder control a code length to spread the narrow-band signal in frequency such that an amplitude is less than a detection threshold.

5. The covert sensor of claim 1, further comprising:
a spontaneous emission noise source configured to add noise to the modulated signal light.

6. The covert sensor of claim 5, wherein an average power of the additional noise is less than an average power of the modulated signal.

7. The covert sensor of claim 5, wherein an average power of the coded waveform and the additional noise is less than an average power of thermal background noise between the transmit and receive apertures.

8. The covert sensor of claim 1, wherein the control circuit decodes the coded waveforms in the received light and compares them to the coded waveforms radiated by the transmitting aperture to refine the delay.

9. The covert sensor of claim 1, wherein a code length is longer than the time-of-flight.

10. The covert sensor of claim 1, wherein the optical delay includes a frequency shifter, wherein the optical detector is a direct detector or heterodyne detector.

11. The covert sensor of claim 1, wherein the control circuit includes a phase lock loop (PLL) filter, wherein the optical detector is a direct detector or homodyne or quasi-homodyne detector.

12. The covert sensor of claim 1, wherein the wavefront generator and encoder are configured to encode messages in a series of the coded waveforms.

13. The covert sensor of claim 1, wherein the control circuit includes a decoder to decode the coded waveforms to recover the narrow-band signal.

14. The covert sensor of claim 1, wherein the phase conjugator is configured to provide-phase sensitive amplification the phase conjugated reference.

15. The covert sensor of claim 1, wherein the entanglement resource comprises a non-liner crysta.

16. A covert sensor, comprising:
a light source configured to generate broadband light;
an entanglement resource that interacts with the broadband light to generate pairs of entangled photons to form a reference and a signal at different wavelengths;
a wavelength separator configured to separate the signal and the reference;
a waveform generator and encoder configured to generate a sequence of coded waveforms for a narrow-band signal, wherein a code length is selected to spread the narrow-band signal in frequency;
a phase modulator configured to modulate the signal with the sequence of coded waveforms and output a modulated modulated signal;
a spontaneous emission noise source configured to add noise to the modulated signal;
a transmitting aperture configured to receive light from the first output and radiate the light in a free-space beam towards a target;
a receiving aperture configured to receive light including coded waveforms from the target;
a phase conjugator configured to mix the reference with the broadband light to shift the reference to the same wavelength as the signal and to perform a phase conjugation to output a phase conjugated reference as a local oscillator;
an optical delay configured to time delay the the local oscillator to approximately match a time-of-flight delay to the target and back;
a receiving aperture configured to receive light including coded waveforms from the target;
an optical detector configured to mix the received light with the time-delayed local oscillator to form one or more signals; and
a control circuit configured to time-correlate the transmitted and received coded waveforms to adjust the time delay and to process the one or more signals to estimate a phase of the light received by the receiving aperture relative to a phase of light radiated by the transmitting aperture to estimate a range to the target.

17. A covert sensor, comprising:
a light source configured to generate broadband light;
an entanglement resource that interacts with the broadband light to generate pairs of entangled photons to form a reference and a signal at different wavelengths;
a wavelength separator configured to separate the signal and the reference;
a waveform generator and encoder configured to generate a sequence of coded waveforms for a narrow-band signal; and
a phase modulator configured to modulate the signal with the sequence of coded waveforms and output a modulated signal.

18. The covert sensor of claim 17, further comprising
a spontaneous emission noise source configured to add noise to the modulated signal such that the coded waveforms are hidden in the noise.

19. The covert sensor of claim 17, wherein the waveform generator and encoder controls a code length to spread the signal in frequency such that an amplitude is less than a detection threshold.

20. The covert sensor of claim 17, wherein an average power of the additional noise is less than an average power of the modulated light, wherein an average power of the coded waveform and the additional noise is less than an average power of thermal background noise between the transmit and receive apertures.
